(19) United States
(12) Patent Application Publication
(10) Pub. No.: US 2012/0053798 A1
(43) Pub. Date: Mar. 1, 2012

(54) VEHICLE FORWARD TRAVELING DETERMINATION APPARATUS AND VEHICLE FORWARD TRAVELING DETERMINATION METHOD

(75) Inventors: Atsuto HIROTA, Chiryu-shi (JP); Kazuhiro KATO, Kariya-shi (JP)

(73) Assignee: ADVICS CO., LTD., Kariya-shi (JP)

(21) Appl. No.: 13/218,248

(22) Filed: Aug. 25, 2011

(30) Foreign Application Priority Data
Aug. 25, 2010 (JP) 2010-188769

(51) Int. Cl. G01M 17/013

(52) U.S. Cl. 701/51

(57) ABSTRACT

A vehicle forward traveling determination apparatus and a vehicle forward traveling determination method are provided. The apparatus includes a transmission gear ratio calculation unit which calculates a transmission gear ratio based on a number of revolutions of a driving source of a vehicle and a value corresponding to a number of revolutions at an output side of a transmission mounted to the vehicle, a gear stage determination unit which determines whether a gear stage of the transmission is set in a forward gear stage based on the calculated transmission gear ratio calculated, an acceleration determination unit which determines whether the vehicle is being accelerated, and a forward traveling determination unit which determines that the vehicle is traveling forward when it is determined that the gear stage of the transmission is set in the forward gear stage and that the vehicle is being accelerated.

### CROSS REFERENCE TO RELATED APPLICATIONS

This application is based on and claims priority under 35 U.S.C. §119 to Japanese Patent Application 2010-188769, filed on Aug. 25, 2010, the entire content of which is incorporated herein by reference.

### BACKGROUND

1. Field of the Invention

The present invention relates to a vehicle forward traveling determination apparatus and a vehicle forward traveling determination method, which determine whether the vehicle is traveling forward.

2. Description of Related Art

In recent years, an ESC (Electronic Stability Control) which suppresses sideslip of a vehicle has been known as an example of a braking control of controlling vehicle behavior. When the sideslip of a vehicle is detected while a driver operates a steering wheel to turn the vehicle or the vehicle travels on a road having a low frictional coefficient (μ), the ESC corrects/holds the traveling direction of the vehicle by individually adjusting braking forces for respective wheels.

Since the ESC typically uses a control model on the assumption that the vehicle is traveling forward, it may be not preferable that the ESC is executed when the vehicle is traveling backward. Accordingly, in the vehicle capable of executing the ESC, it is necessary to correctly determine whether the vehicle is traveling forward or backward. Accordingly, JP-A-2002-236133 has proposed an apparatus of determining whether a vehicle is traveling forward or not.

The forward traveling determination apparatus described in JP-A-2002-236133 has a memory that in advance stores therein transmission gear ratios for forward gear stages and a transmission gear ratio for reverse gear stage. The transmission gear ratio indicates a value that is obtained by dividing the number of revolutions of an engine by a vehicle body speed of a vehicle. In the forward traveling determination apparatus, the number of revolutions of the engine and the vehicle body speed at the present time are acquired and a transmission gear ratio at the present time is calculated based on the acquisition result. Based on a comparison result between the transmission gear ratio calculated as described above and the respective transmission gear ratios stored in the memory, it is determined whether the gear stage of a transmission is set in a forward gear stage or not. Then, when the gear stage of the transmission is set in a forward gear stage, it is determined that the vehicle is traveling forward. In other words, a forward traveling determination flag is set as “1.” As a result, when the forward traveling determination flag is set as “1”, execution of the ESC is permitted and when the forward traveling determination flag is set as “0 (zero)”, the execution of the ESC is prohibited.

However, the above-described forward traveling determination apparatus may falsely determine that the vehicle is traveling forward even though the vehicle is actually traveling backward. In other words, when the transmission is set at the reverse gear stage to move the vehicle backward and then the power transmission from an engine to driving wheels is interrupted, the vehicle body speed of the vehicle is gradually decreased and the number of revolutions of the engine is rapidly reduced unless an accelerator pedal is stepped. Accordingly, a transmission gear ratio that is calculated on the basis of the number of revolutions of the engine and the vehicle body speed of the vehicle becomes sufficiently smaller than a transmission gear ratio of the reverse gear stage and thus comes close to a transmission gear ratio of the forward gear stage. Thus, it may be falsely determined that the gear stage of the transmission is set in the forward gear stage. As a result, even though the vehicle is traveling backward, it is falsely determined that the vehicle is traveling forward.

The above problem may occur irrespective of whether the transmission mounted in the vehicle is a manual transmission or automatic transmission. In the vehicle having the manual transmission mounted therein, when a clutch is released or a position of a shift lever is changed from an R (reverse) range to a neutral range at the reversing time, the power transmission from the engine to the driving wheels is interrupted. Hence, it may be falsely determined that the vehicle is traveling forward. In the vehicle having the automatic transmission mounted therein, when the position of the shift lever is changed from an R (reverse) range to a neutral range at the reversing time, the power transmission from the engine to the driving wheels is interrupted. Hence, it may be falsely determined that the vehicle is traveling forward.

### SUMMARY

The present invention has been made in view of the above circumstances, and it is an object of the present invention to provide a vehicle forward traveling determination apparatus and a vehicle forward traveling determination method which are capable of accurately determining whether a vehicle is traveling forward or not.

According to an illustrative embodiment of the present invention, there is provided a vehicle forward traveling determination apparatus comprising: a first acquisition unit configured to acquire a number of revolutions of a driving source of a vehicle; a second acquisition unit configured to acquire a value corresponding to a number of revolutions at an output side of a transmission mounted to the vehicle; a transmission gear ratio calculation unit configured to calculate a transmission gear ratio based on the respective values acquired in the respective first and second acquisition units; a gear stage determination unit configured to determine whether a gear stage of the transmission is set in a forward gear stage, based on the transmission gear ratio calculated by the transmission gear ratio calculation unit; an acceleration determination unit configured to determine whether the vehicle is being accelerated; and a forward traveling determination unit configured to determine that the vehicle is traveling forward when the gear stage determination unit determines that the gear stage of the transmission is set in the forward gear stage and the acceleration determination unit determines that the vehicle is being accelerated.

According to the above configuration, the number of revolutions of the driving source and the value corresponding to the number of revolutions at the output side of the transmission are acquired and the transmission gear ratio is calculated based on the acquisition result. Then, when it is determined that the gear stage of the transmission is set in the forward gear stage based on the calculated transmission gear ratio and when it is determined that the vehicle is being accelerated, it is determined that the vehicle is traveling forward. When the vehicle is moved backward at a state in which the gear stage of the transmission is set in a reverse gear stage and the power transmission from the driving source to the transmission is interrupted, there is a low possibility that the vehicle will be accelerated. Accordingly, a possibility that it will be falsely determined that the vehicle is traveling forward can be lowered. Hence, compared to a case where there is only the determination criterion of determining whether the gear stage of the transmission is the forward gear stage or not, it is possible to improve the determination accuracy of determining whether the vehicle is traveling forward or not.

According to another illustrative embodiment of the present invention, there is provided a vehicle forward traveling determination method comprising: calculating a transmission gear ratio based on a number of revolutions of a driving source of a vehicle and a value corresponding to a number of revolutions at an output side of a transmission mounted to the vehicle; determining whether a gear stage of the transmission is set in a forward gear stage based on the calculated transmission gear ratio; determining whether the vehicle is being accelerated; and determining that the vehicle is traveling forward when it is determined that the gear stage of the transmission is set in the forward gear stage and it is determined that the vehicle is being accelerated.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a block diagram showing an example of a vehicle in which a forward traveling determination apparatus according to an illustrative embodiment is mounted;

FIG. 2 is a map showing a relation between the number of revolutions of an engine and a vehicle body speed of a vehicle for each gear stage;

FIG. 3 is a flowchart showing a forward traveling determination processing routine according to an illustrative embodiment;

FIG. 4 is a timing chart showing changes of an estimated transmission gear ratio;

FIG. 5 is a flowchart showing an ESC processing routine according to an illustrative embodiment;

FIG. 6 is a flowchart showing a main process of a forward traveling determination processing routine according to another illustrative embodiment;

FIG. 7 is a map showing a relation between the number of revolutions of an engine and a vehicle body speed of a vehicle for each gear stage according to another illustrative embodiment; and

FIG. 8 is a map showing a relation between the number of revolutions of an engine and a vehicle body speed of a vehicle for each gear stage according to still another illustrative embodiment.

### DETAILED DESCRIPTION

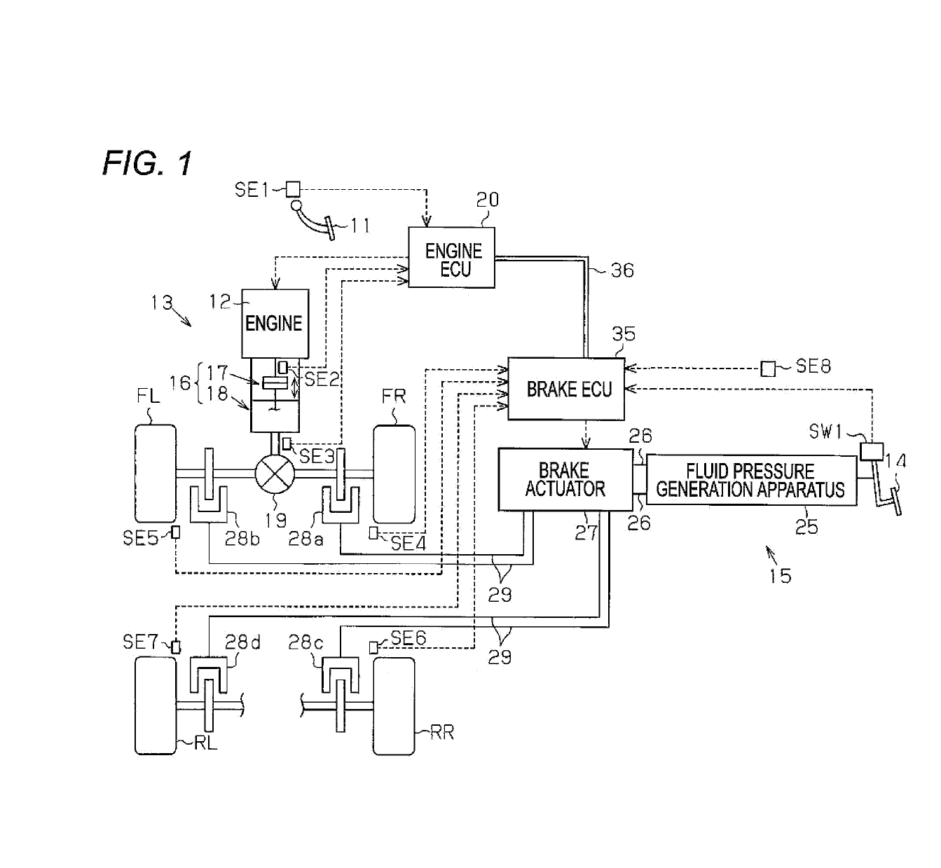

Hereinafter, an illustrative embodiment of the present invention will be described with reference to FIGS. 1 to 5. In the below descriptions, a traveling direction (forward direction) of a vehicle is described as the front (vehicle front).

As shown in FIG. 1, a vehicle is a so-called front-wheel driving vehicle in which front wheels FR, FL of a plurality of wheels (four wheels in this illustrative embodiment) (front right wheel FR, front left wheel FL, rear right wheel RR and rear left wheel RL) function as driving wheels. The vehicle is provided with a driving apparatus 13 having an engine 12 (an example of a driving source) that generates driving force corresponding to an operation amount of an accelerator pedal 11 by a driver and a braking apparatus 15 that applies braking force corresponding to an operation amount of a brake pedal 14 by the driver to the respective wheels FR, FL, RR, RL.

In the below, the driving apparatus 13 according to this illustrative embodiment is described. The driving apparatus 13 has a fuel injection apparatus (not shown) having an injector arranged adjacent to a suction port (not shown) of the engine 12 and injecting fuel into the engine 12. An output side of the engine 12 is provided with a transmission 16. The transmission 16 of this illustrative embodiment is a manual transmission and has a clutch 17 that is operated as the driver steps a clutch pedal (not shown) and a transmission mechanism 18 that is arranged at an output side of the clutch 17.

The clutch 17 interrupts the power transmission from the engine 12 to the transmission mechanism 18 when the clutch pedal is stepped and permits the power transmission from the engine 12 to the transmission mechanism 18 when the stepping on the clutch pedal is released. In the meantime, the state of the clutch in which the power transmission is interrupted is referred to as “state in which the clutch 17 is released” and the state of the clutch in which the power transmission is permitted is referred to as “state in which the clutch 17 is engaged.”

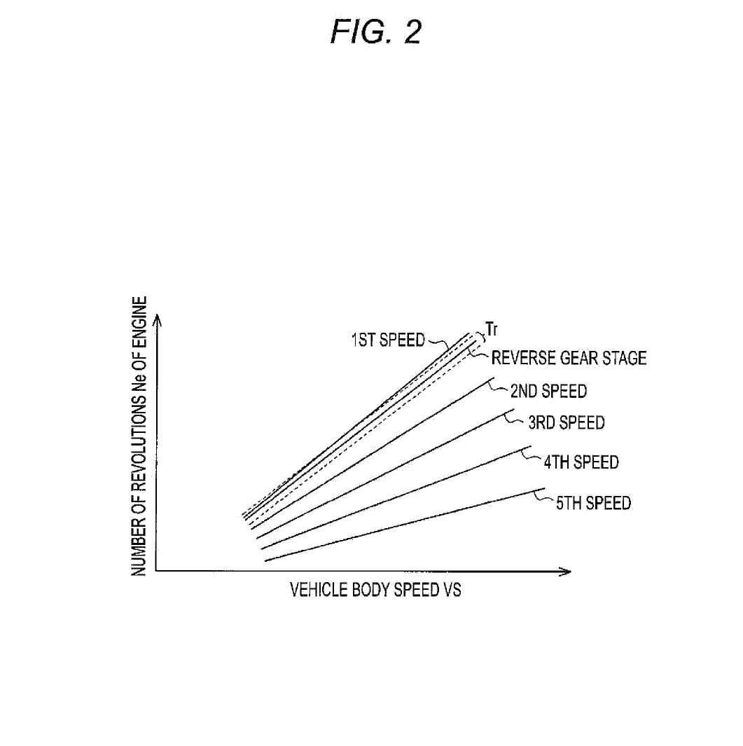

Also, the transmission mechanism 18 has a forward gear stage(s) and a reverse gear stage. The gear stage of the transmission mechanism 18 is set as a gear stage corresponding to an operation of a shift lever (not shown) by the driver. As shown in FIG. 2, the transmission 16 of this illustrative embodiment is a transmission having gear stages of forward 5th speed and reverse 1 speed. A transmission gear ratio of the gear stage of 1st speed is highest among the transmission gear ratios of the respective forward gear stages (1st speed, 2nd speed, 3rd speed, 4th speed and 5th speed), a transmission gear ratio of the gear stage of 2nd speed is second highest and a transmission gear ratio of the gear stage of 3rd speed is third highest. Also, a transmission gear ratio of the gear stage of 4th speed is fourth highest and a transmission gear ratio of the gear stage of 5th speed is lowest. In addition, a transmission gear ratio of the reverse gear stage (which is also referred to as “reverse transmission gear ratio”) is slightly lower than the transmission gear ratio of the gear stage of 1st speed and is sufficiently higher than the transmission gear ratio of the gear stage of 2nd speed. In this illustrative embodiment, the “transmission gear ratio” is a value that is obtained by dividing the number of revolutions of the engine, which is the output of the engine 12, by the vehicle body speed of the vehicle.

As shown in FIG. 1, the output side of the transmission 16 is provided with a differential gear 19. The differential gear 19 appropriately allocates the driving force transmitted from the transmission 16 and transmits the same to the front wheels FR, FL, which are the driving wheels. Accordingly, the driving force generated in the engine 12 is transmitted to the front wheels FR, FL via the transmission 16 and the differential gear 19, so that the vehicle travels forward or backward.

The driving apparatus 13 is driven, based on the control of an engine ECU 20 (which is also referred to as “engine electronic control unit”) having a CPU, a ROM, a RAM and the like (not shown). The engine ECU 20 is electrically connected with an accelerator position sensor SE1 that is provided adjacent to the accelerator pedal 11. The accelerator position sensor SE1 outputs a detection signal, which corresponds to the operation amount of the accelerator pedal 11 by the driver, i.e., an accelerator position, to the engine ECU 20.

In addition, the engine ECU 20 is electrically connected with a first revolutions detection sensor SE2 that detects the number of revolutions of the output side of the engine 12 (hereinafter, referred to as “the number of revolutions of the engine”) and a second revolutions detection sensor SE3 that detects the number of revolutions of the output side of the transmission 16 (hereinafter, referred to as “the number of revolutions after shift transmission”). The respective revolutions detection sensors SE2, SE3 output detection signals, which correspond to the number of revolutions of the engine and the number of revolutions after shift transmission, to the engine ECU 20, respectively.

The engine ECU 20 calculates the accelerator position, the number of revolutions of the engine and the number of revolutions after shift transmission, based on the detection signals of the respective sensors SE1 to SE3. Then, the engine ECU 20 controls the driving apparatus 13, based on the calculated accelerator position, respective numbers of revolutions and the like.

Next, the braking apparatus 15 according to this illustrative embodiment is described. The braking apparatus 15 has a fluid pressure generation apparatus 25 having a master cylinder, a booster and a reservoir, which are not shown, and a brake actuator 27 that is coupled to the fluid pressure generation apparatus 25 via coupling flow paths 26. The brake actuator 27 is coupled to a wheel cylinder 28a for front right wheel FR, a wheel cylinder 28b for front left wheel FL, a wheel cylinder 28c for rear right wheel RR and a wheel cylinder 28d for rear left wheel RL via connection flow paths 29.

When the brake pedal 14 is operated by the driver, a master cylinder pressure corresponding to the operation amount (which may be referred to as “stepping amount”) is generated in the master cylinder of the fluid pressure generation apparatus 25. At this time, brake fluid is supplied into the respective wheel cylinders 28a to 28d from the master cylinder, so that the substantially same wheel cylinder pressures as the master cylinder pressure are generated therein. As a result, the wheels FR, FL, RR, RL are applied with braking forces corresponding to the wheel cylinder pressures in the wheel cylinders 28a to 28d. In addition, a brake switch SW1 for detecting whether the brake pedal 14 is operated is provided adjacent to the brake pedal 14 with respect to the fluid pressure generation apparatus 25. From the brake switch SW1, a detection signal corresponding to the operation state of the brake pedal 14 is output to a brake ECU 35.

The brake actuator 27 can individually adjust the wheel cylinder pressures in the wheel cylinders 28a to 28d even when the brake pedal 14 is not operated. In other words, the brake actuator 27 is configured to individually adjust the braking forces for the respective wheels FR, FL, RR, RL. For example, the brake actuator 27 has a pump (not shown) that is operated to adjust the wheel cylinder pressures of the wheel cylinders 28a to 28d and a differential pressure adjustment value (not shown) that is operated to adjust differential pressures between the master cylinder and the wheel cylinders. In addition, the brake actuator 27 is provided with holding valves (not shown) that are operated when holding the wheel cylinder pressures and pressure reduction valves (not shown) that are operated when reducing the wheel cylinder pressures, for the respective wheels FR, FL, RR, RL.

Next, the brake ECU 35 (which is also referred to as “brake electronic control unit”), which is a braking control apparatus of controlling the braking apparatus 15 according to this illustrative embodiment, is described. The brake ECU 35 is electrically connected at its input-side interface with wheel speed sensors SE4, SE5, SE6, SE7 for detecting wheel speeds of the respective wheels FR, FL, RR, RL, a forward and backward acceleration sensor SE8 for detecting acceleration in forward and backward directions of the vehicle and the brake switch SW1. Also, the input-side interface is electrically connected with a steering angel sensor (not shown) for detecting a steering angle of a steering (not shown) of the vehicle, a yaw rate sensor (not shown) for detecting a yaw rate of the vehicle and a lateral acceleration sensor (not shown) for detecting acceleration in a lateral direction of the vehicle. In addition, the brake ECU 35 is electrically connected at its output-side interface with motors, which are driving sources of the respective valves and pumps configuring the brake actuator 27, and the like.

The brake ECU 35 has a digital computer (not shown) configured by a CPU, a ROM, a RAM and the like, which are not shown, a driver circuit (not shown) for driving the brake actuator 27, and the like. The ROM of the digital computer stores therein a variety of control processes (forward traveling determination process and the like), a variety of maps (map shown in FIG. 2, and the like), a variety of thresholds and the like in advance. Also, the RAM stores therein a variety of information that is appropriately updated while an ignition switch (not shown) is on.

Next, the map that is stored in the ROM of the brake ECU 35 is described with reference to FIG. 2. The map shown in FIG. 2 is an example of a map that indicates a relation between the vehicle body speed VS of the vehicle and the number of revolutions Ne of the engine for the respective gear stages of the transmission 16. As shown in FIG. 2, when the transmission gear ratio of the transmission 16 is not changed, the vehicle body speed VS changes in a linear function according to the change of the number of revolutions Ne of the engine. Also, when linearly expressing the relation between the vehicle body speed VS and the number of revolutions Ne of the engine for the respective gear stages, a slope of each line corresponds to the high-low of the transmission gear ratio of the transmission 16. The transmission gear ratio (estimated transmission gear ratio) is calculated based on the vehicle body speed VS and the number of revolutions Ne of the engine at the present time, and the gear stage of the transmission 16 at the present time is estimated by using the calculated transmission gear ratio and the map of FIG. 2.

In the vehicle of this illustrative embodiment, the ECUs including the engine ECU 20 and the brake ECU 35 are connected to each other via a bus 36 so that a variety of information and a variety of control instructions can be transmitted and received, as shown in FIG. 1. For example, from the engine ECU 20, the information about the accelerator position of the accelerator pedal 11, the information about the number of revolutions Ne of the engine and the like are appropriately transmitted to the brake ECU 35. In the meantime, from the brake ECU 35, the information about the vehicle body speed VS of the vehicle and the like are transmitted to the engine ECU 20.

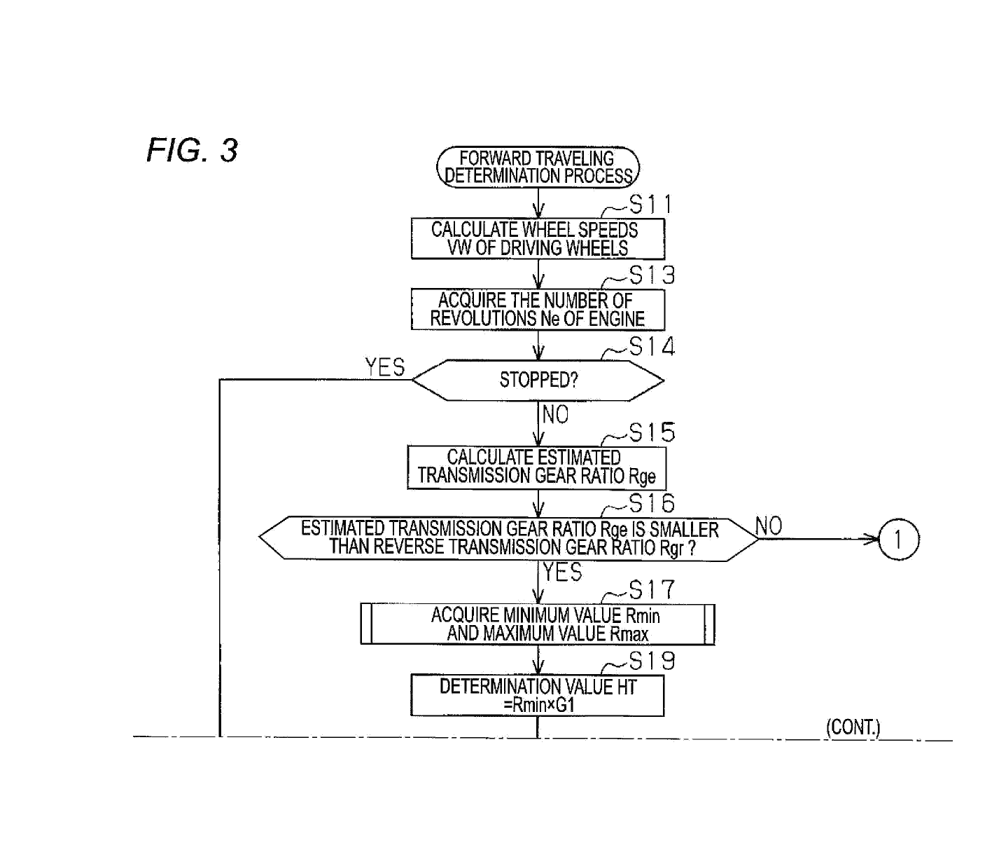

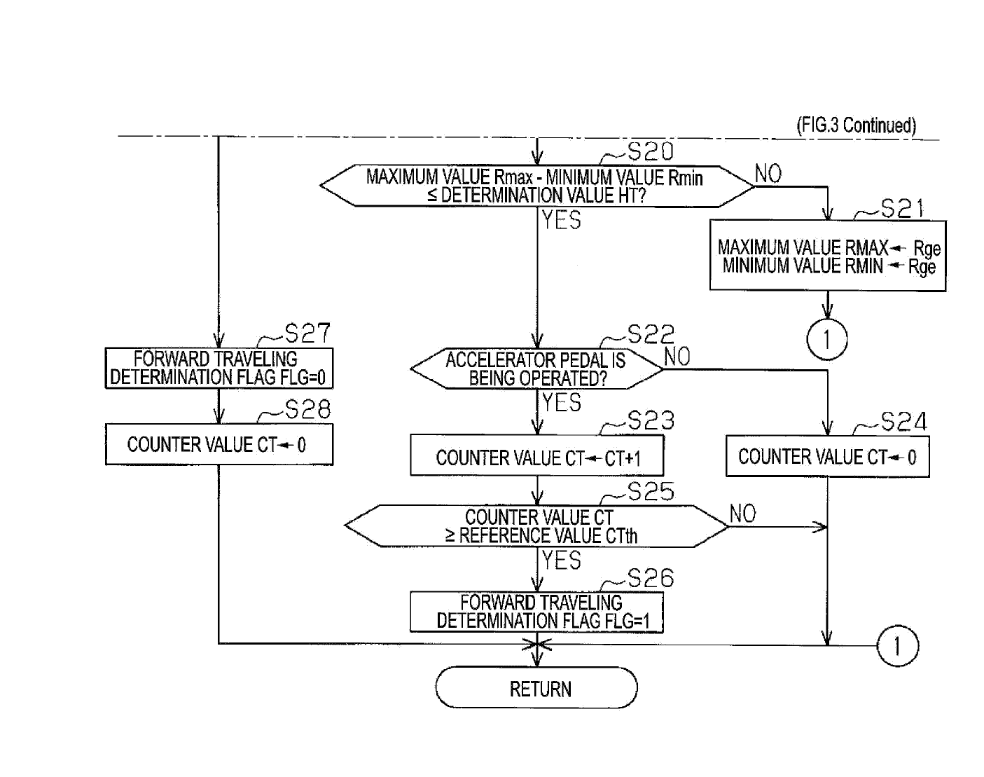

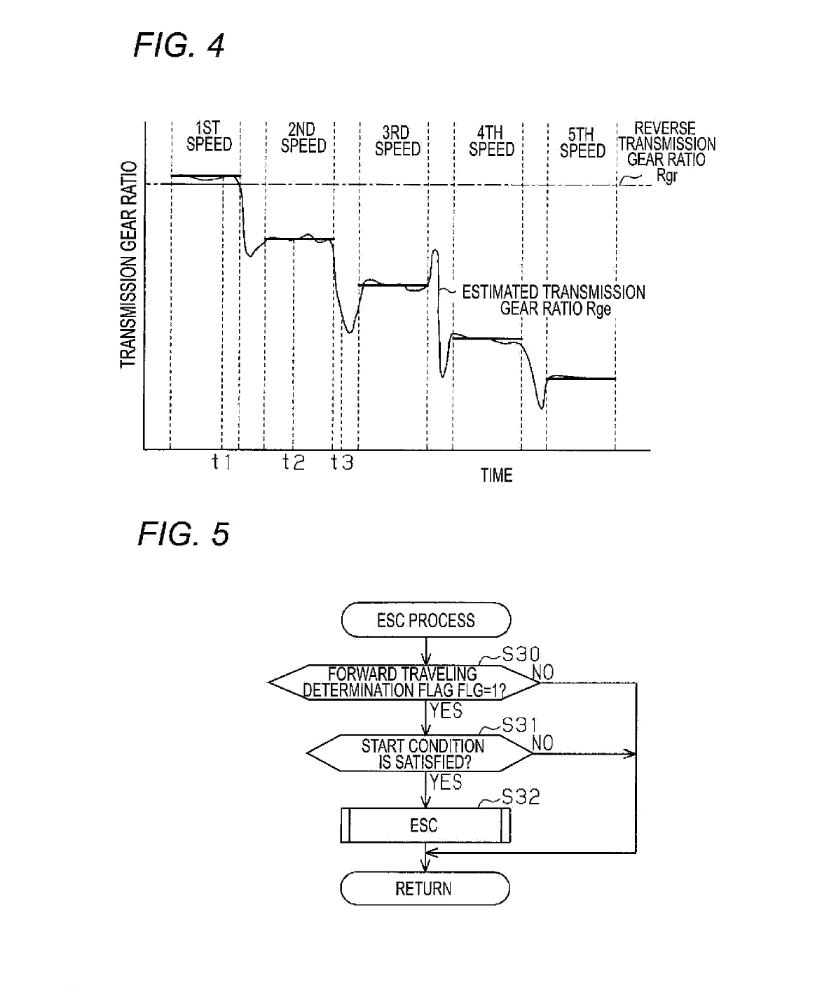

Next, a forward traveling determination processing routine among various control processing routines that are executed by the brake ECU 35 of this illustrative embodiment is described with reference to a flowchart shown in FIG. 3 and a timing chart shown in FIG. 4. The forward traveling determination processing routine is a processing routine for determining whether the vehicle is traveling forward or not.

The brake ECU 35 executes the forward traveling determination processing routine every predetermined period (for example, every 0.006 second). In the forward traveling determination processing routine, the brake ECU 35 calculates the wheel speeds VW of the driving wheels, as an example of a speed corresponding to the number of revolutions of the output side of the transmission 16 (step S11). In this illustrative embodiment, the front wheels FR, FL are the driving wheels. Accordingly, the brake ECU 35 calculates the wheel speeds VW of the front wheels FR, FL, based on the detection signals of the wheel speed sensors SE4, SE5 for front wheels FR, FL.

Then, the brake ECU 35 acquires the number of revolutions Ne of the engine received from the engine ECU 20 (step S13). Subsequently, the brake ECU 35 acquires the vehicle body speed of the vehicle and determines whether the vehicle is stopped or not, based on the acquired vehicle body speed (step S14). When a result of the determination in step S14 is negative, the brake ECU 35 calculates an estimated transmission gear ratio Rge (step S15). Specifically, the brake ECU 35 acquires the estimated transmission gear ratio Rge by dividing the number of revolutions Ne of the engine, which is acquired in step S13, by an average value of the wheel speeds VW of the respective front wheels FR, FL, which are calculated in step S11.

Subsequently, the brake ECU 35 determines whether the estimated transmission gear ratio Rge, which is calculated in step S15, is lower than a reverse transmission gear ratio Rgr (step S16). Here, when the gear stage of the transmission 16 is set in the reverse gear stage and the power transmission from the engine 12 to the front wheels FR, FL is permitted, the estimated transmission gear ratio Rge will become the substantially same transmission gear ratio as the reverse transmission gear ratio Rgr. That is, as shown in FIG. 2, the estimated transmission gear ratio Rge should be included in a reverse determination area Tr including a predetermined error component (for example, error component of “±3%”) about the reverse transmission gear ratio Rgr. Also, as shown in the timing chart of FIG. 4, when the gear stage of the transmission 16 is set in the gear stage of 1st speed, the estimated transmission gear ratio Rge becomes the substantially same transmission gear ratio as a theoretical value of the transmission gear ratio of the gear stage of 1st speed (first timing t1).

In this illustrative embodiment, the reverse transmission gear ratio Rgr is set to be close to a theoretical value of the transmission gear ratio of the gear stage of 1st speed, considering the vehicle characteristics. As a result, when the estimated transmission gear ratio Rge has a value close to the theoretical value of the transmission gear ratio of the gear stage of 1st speed, it might be difficult to correctly determine whether the gear stage of the transmission 16 is the reverse gear stage or the gear stage of 1st speed. Therefore, in this illustrative embodiment, when the gear stage of the transmission 16 is determined as the gear stage of 1st speed, it is determined that there is a possibility that the gear stage of the transmission 16 is set in the reverse gear stage.

On the other hand, when the gear stage of the transmission 16 is set in the forward gear stage (for example, gear stage of 2nd speed) except for the gear stage of 1st speed, the estimated transmission gear ratio Rge becomes lower than the reverse determination area Tr. For example, when the gear stage of the transmission 16 is set in the gear stage of 2nd speed, the estimated transmission gear ratio Rge becomes the substantially same transmission gear ratio as that of the gear stage of 2nd speed (second timing t2). In this case, it is determined that the gear stage of the transmission 16 is set in the forward gear stage.

In the meantime, even though the gear stage of the transmission 16 is set in the reverse gear stage, when the power transmission from the engine 12 to the front wheels FR, FL is interrupted, the estimated transmission gear ratio Rge is out of the reverse determination area Tr. Particularly, when the accelerator pedal 11 is not operated, the estimated transmission gear ratio Rge has a value closer to the transmission gear ratio of the forward gear stage (in this illustrative embodiment, the other forward gear stages except for the gear stage of 1st speed) than the reverse transmission gear ratio Rgr. Accordingly, when the power transmission from the engine 12 to the front wheels FR, FL is interrupted, there is a possibility that it will be determined that the gear stage of the transmission 16 is set in the forward gear stage.

Here, the case where “the power transmission from the engine 12 to the front wheels FR, FL is interrupted” indicates a case where at least one of a first condition that the clutch 17 is released and a second condition that a position of the shift lever is at the neutral range is satisfied. In the meantime, the case where “the power transmission from the engine 12 to the front wheels FR, FL is permitted” indicates a case where both the first condition and the second condition are not satisfied.

When a result of the determination in step S16 is negative, the brake ECU 35 ends the forward traveling determination processing routine since there is a possibility that the gear stage of the transmission 16 is set in the reverse gear stage. It is noted that, when at least one of a first condition where the estimated transmission gear ratio Rge<the reverse transmission gear ratio Rgr×0.7, a second condition where the estimated transmission gear ratio Rge<(the reverse transmission gear ratio Rgr−0.5) and a third condition where ((an absolute value of the difference between the estimated transmission gear ratio Rge and the reverse transmission gear ratio Rgr)/the reverse transmission gear ratio Rgr)<0.03 is satisfied, a result of the determination in step S16 becomes negative. However, only one of the three conditions may be used to determine whether a result of the determination in step S16 is negative or not. For example, only the condition of the estimated transmission gear ratio Rge<the reverse transmission gear ratio Rgr×0.7 may be used to determine whether a result of the determination in step S16 is negative or not. In this case, when the estimated transmission gear ratio Rge≧the reverse transmission gear ratio Rgr×0.7, a result of the determination in step S16 becomes positive.

On the other hand, when a result of the determination in step S16 is positive, the process proceeds to a next step S17 since there is a low possibility that the gear stage of the transmission 16 is set in the reverse gear stage.

In step S17, the brake ECU 35 obtains the minimum value Rmin and the maximum value Rmax of the transmission gear ratio, based on the estimated transmission gear ratio Rge calculated in step S15. Specifically, when the estimated transmission gear ratio Rge calculated in step S15 is smaller than the minimum value Rmin of the transmission gear ratio at the present time, the brake ECU 35 sets the estimated transmission gear ratio Rge as the minimum value Rmin of the transmission gear ratio. When the estimated transmission gear ratio Rge calculated in step S15 is larger than the maximum value Rmax of the transmission gear ratio at the present time, the brake ECU 35 sets the estimated transmission gear ratio Rge as the maximum value Rmax of the transmission gear ratio. That is, the brake ECU 35 updates the minimum value Rmin and the maximum value Rmax of the transmission gear ratio.

Subsequently, the brake ECU 35 multiplies the minimum value Rmin of the transmission gear ratio acquired in step S17 by a predetermined gain value (for example, 3%) G1 and sets a result of the multiplication as a determination value HT (step S19). The gain value G1 is a value to which the error component of the estimated transmission gear ratio Rge is added. Then, the brake ECU 35 determines whether a difference (=Rmax−Rmin) between the minimum value Rmin and the maximum value Rmax of the transmission gear ratio obtained in step S17 is equal to or smaller than the determination value HT calculated in step S19 (step S20).

When the driving force is transmitted from the engine 12 to the front wheels FR, FL, which are the driving wheels, the estimated transmission gear ratio Rge is little changed unless the gear stage of the transmission 16 is changed. In the meantime, when the power transmission from the engine 12 to the front wheels FR, FL is interrupted, the estimated transmission gear ratio Rge is largely changed. Therefore, when a result of the determination in step S20 is positive ((Rmax−Rmin)≦HT), the brake ECU 35 determines that the power transmission from the engine 12 to the front wheels FR, FL is permitted, and proceeds to step S22 that will be described later.

On the other hand, when a result of the determination in step S20 is negative ((Rmax−Rmin)>HT), the brake ECU 35 determines that the power transmission from the engine 12 to the front wheels FR, FL is interrupted. Then, the brake ECU 35 sets the minimum value Rmin and the maximum value Rmax of the transmission gear ratio as the estimated transmission gear ratio Rge calculated in step S15 (step S21) and once ends the forward traveling determination processing routine.

That is, as shown in the timing chart of FIG. 4, when the clutch 17 is released, the power transmission from the engine 12 to the front wheels FR, FL is interrupted, so that the estimated transmission gear ratio Rge is largely changed (third timing t3). Accordingly, even when the minimum value Rmin and the maximum value Rmax of the transmission gear ratio are obtained based on the estimated transmission gear ratio Rge, the difference thereof (=Rmax−Rmin) becomes larger than the determination value HT. In other words, the difference between the estimated transmission gear ratio Rge obtained at present time and the estimated transmission gear ratio Rge obtained at the previous time becomes greater than the determination value HT. On the other hand, when the clutch 17 is engaged, the estimated transmission gear ratio Rge is changed a little (second timing t2). Accordingly, in this case, when the minimum value Rmin and the maximum value Rmax of the transmission gear ratio are obtained based on the estimated transmission gear ratio Rge, there is a high possibility that the difference thereof (=Rmax-Rmin) will be not larger than the determination value HT.

Referring to the flowchart of FIG. 3, the brake ECU 35 determines in step S22 whether the accelerator pedal 11 is being operated (step S22). When the accelerator pedal 11 is being operated, it may be determined that the vehicle is being accelerated or the driver has an intention to accelerate the vehicle. That is, in this illustrative embodiment, it is determined whether the vehicle is being accelerated based on whether the accelerator pedal 11 is being operated. When a result of the determination in step S22 is positive, the brake ECU 35 determines that there is a possibility that the vehicle is being accelerated and increases a counter value CT by “one” (step S23), and then proceeds to step S25 that will be described later. On the other hand, when a result of the determination in step S22 is negative, the brake ECU 35 determines that there is a high possibility that the vehicle is not being accelerated, resets the counter value CT as “0 (zero)” (step S24) and then ends the forward traveling determination processing routine. Here, the counter value CT is for counting the time period within which the accelerator pedal 11 is being operated or the counter value CT may be considered as an elapsed time period after detecting the operation of the accelerator pedal 11.

In step S25, the brake ECU 35 determines whether the counter value CT updated in step S23 is a predetermined reference value CTth (for example, 2) or greater. The reference value CTth is a value that is set for suppressing the false determination that the vehicle is being accelerated even though the vehicle is not actually being accelerated, and is preset by a test, a simulation and the like.

When a result of the determination in step S25 is negative (CT<CTth), the brake ECU 35 once ends the forward traveling determination processing routine. On the other hand, when a result of the determination in step S25 is positive (CT≧CTth), the brake ECU 35 determines that the vehicle is being accelerated, and sets “1” for a forward traveling determination flag FLG (step S26). The forward traveling determination flag FLG is a flag that is set in “1” when it is determined that the vehicle is traveling forward.

In the meantime, when a result of the determination in step S14 is positive, the brake ECU 35 resets the forward traveling determination flag FLG in “0 (zero)” since the vehicle is stopped (step S27). That is, in this illustrative embodiment, once it is determined during the traveling of the vehicle that the vehicle is traveling forward, the forward traveling determination flag FLG is not reset in “0 (zero)” until it is determined that the vehicle is stopped. In other words, it is continued to be determined that the vehicle is traveling forward until the vehicle is stopped. This is because it is necessary to stop the vehicle to travel backward even though the stop time is very short. Then, the brake ECU 35 resets the counter value CT in “0 (zero)” (step S28) and ends the forward traveling determination processing routine.

Next, the ESC processing routine that is executed by the brake ECU 35 is described with reference to the flowchart shown in FIG. 5. The ESC processing routine is a processing routine for executing the ESC (Electronic Stability Control) as a sideslip suppression control for suppressing the sideslip of the vehicle.

The brake ECU 35 executes the ESC processing routine every predetermined period (for example, 0.006 second). In the ESC processing routine, the brake ECU 35 determines whether the forward traveling determination flag FLG is set as “1” or not (step S30). When a result of the determination is negative (FLG=0), the brake ECU 35 ends the ESC processing routine. On the other hand, when a result of the determination in step S30 is positive (FLG=1), the brake ECU 35 determines whether a start condition of the ESC is satisfied (i.e., the sideslip or sideslip tendency of the vehicle is detected) (step S31). When a result of the determination thereof is negative, the brake ECU 35 determines that it is not necessary to execute the ESC, and ends the ESC processing routine.

On the other hand, when a result of the determination in step S31 is positive, the brake ECU 35 executes the ESC since the sideslip or sideslip tendency of the vehicle has been detected (step S32). That is, the brake ECU 35 individually adjusts the braking forces for the respective wheels FR, FL, RR, RL, thereby suppressing the sideslip of the vehicle.

According to this illustrative embodiment, following operational effects can be obtained.

(1) When the vehicle travels backward at the state in which the gear stage of the transmission 16 is set in the reverse gear stage and the power transmission from the engine 12 to the front wheels FR, FL, which are the driving wheels, is interrupted, there is a low possibility that the vehicle will be accelerated. Accordingly, in this illustrative embodiment, the estimated transmission gear ratio Rge is calculated based on the number of revolutions Ne of the engine and the wheel speeds VW of the front wheels FR, FL. Then, even when it is determined based on the estimated transmission gear ratio Rge that the gear stage of the transmission 16 is set in the forward gear stage (in this illustrative embodiment, gear stages of 2nd speed, 3rd speed, 4th speed and 5th speed), the forward traveling determination flag FLG is not set as “1” unless the vehicle is being accelerated. Accordingly, regarding the determination criteria for determining whether the vehicle is traveling forward or not, the determination condition of determining whether the vehicle is being accelerated is added, so that a possibility is lowered in which it will be falsely determined that the vehicle is traveling forward even though the vehicle is actually traveling backward, compared to the case where there is only the determination criterion of determining whether the gear stage of the transmission 16 is the forward gear stage or not. As a result, it is possible to improve the determination accuracy of determining whether the vehicle is traveling forward or not.

(2) When the vehicle is positioned on an uphill road, if the power transmission from the engine 12 to the front wheels FR, FL is interrupted, the vehicle may be accelerated backward. In this case, the estimated transmission gear ratio Rge, which is calculated based on the number of revolutions Ne of the engine and the wheel speeds VW of the front wheels FR, FL, is changed each time the forward traveling determination processing routine is executed. This is because even though the vehicle body speed VS is changed, the number of revolutions Ne of the engine is little changed unless the accelerator pedal 11 is operated. Also, the accelerator pedal 11 may be operated even when the power transmission from the engine 12 to the front wheels FR, FL is interrupted. Even in this case, the estimated transmission gear ratio Rge is not stabilized, contrary to the case where the driving force from the engine 12 is transmitted to the front wheels FR, FL.

Accordingly, in this illustrative embodiment, it is determined whether the driving force is transmitted from the engine to the front wheels FR, FL, based on the degree of the change in the estimated transmission gear ratio Rge. When it is determined that there is a possibility that the power transmission from the engine 12 to the front wheels FR, FL is interrupted, it is not determined whether the vehicle is traveling forward or not. On the other hand, when it is determined that the driving force is transmitted from the engine to the front wheels FR, FL, it is determined that the gear stage of the transmission 16 is set in the forward gear stage (in this illustrative embodiment, gear stages of 2nd speed, 3rd speed, 4th speed and 5th speed), based on the estimated transmission gear ratio Rge, and it is determined that the vehicle is traveling forward when it is determined that the vehicle is being accelerated. Accordingly, it is possible to further improve the determination accuracy of determining whether the vehicle is traveling forward.

(3) As an example of the method of determining whether the vehicle is traveling forward or not, a method is considered in which the forward traveling determination flag FLG is set as “1” when it is determined that the vehicle is traveling forward during the traveling of the vehicle, and the forward traveling determination flag FLG is set as “0 (zero)” when there remains a possibility that the vehicle is not traveling forward (for example, the result of the determination in steps S16, S20, S22 and S25 in the forward traveling determination processing routine is negative). In this case, when the forward traveling determination flag FLG becomes “0 (zero)”, the respective processes of the steps S31 and S32 in the ESC processing routine are not executed. In other words, there is a concern that the ESC will not be executed just because there remains a possibility that the vehicle is not traveling forward. However, according to this illustrative embodiment, once the forward traveling determination flag FLG is set in “1”, this setting is maintained until the vehicle is stopped. At the moment that the vehicle is shifted from the forward traveling state to the backward traveling state, the vehicle body speed inevitably becomes “0 (zero).” That is, once it is confirmed that the vehicle is traveling forward, the state that the forward traveling determination flag FLG is “1” is maintained until the vehicle is stopped. Therefore, once the forward traveling determination flag FLG is set in “1” during the traveling of the vehicle, it is possible to securely execute the ESC when the start condition of the ESC is satisfied.

(4) In this illustrative embodiment, when the forward traveling determination flag FLG is set in “1”, the possibility that the vehicle is actually traveling backward is low. Therefore, it is possible to suppress the ESC of the control model which assumes that the vehicle is traveling forward from being executed when the vehicle is actually traveling backward.

(5) As an example of the method of calculating the estimated transmission gear ratio Rge, a method of using the vehicle body speed of the vehicle instead of the wheel speeds VW of the driving wheels can be considered. The vehicle body speed is calculated by using the wheel accelerations of the non-driving wheels (in this illustrative embodiment, rear wheels RR, RL) when the driver of the vehicle does not operate the brake pedal 14. That is, since the driving force from the engine 12 is directly expressed at the driving wheels, the wheel speeds VW of the driving wheels are more appropriate as the value corresponding to the number of revolutions of the output-side of the transmission 16, rather than the vehicle body speed. Therefore, in this illustrative embodiment, the estimated transmission gear ratio Rge is calculated by using the wheel speeds VW of the driving wheels. Accordingly, it is possible to improve the estimation accuracy of the estimated transmission gear ratio Rge.

While the present invention has been shown and described with reference to certain illustrative embodiments thereof, it will be understood by those skilled in the art that various changes in form and details may be made therein without departing from the spirit and scope of the invention as defined by the appended claims.

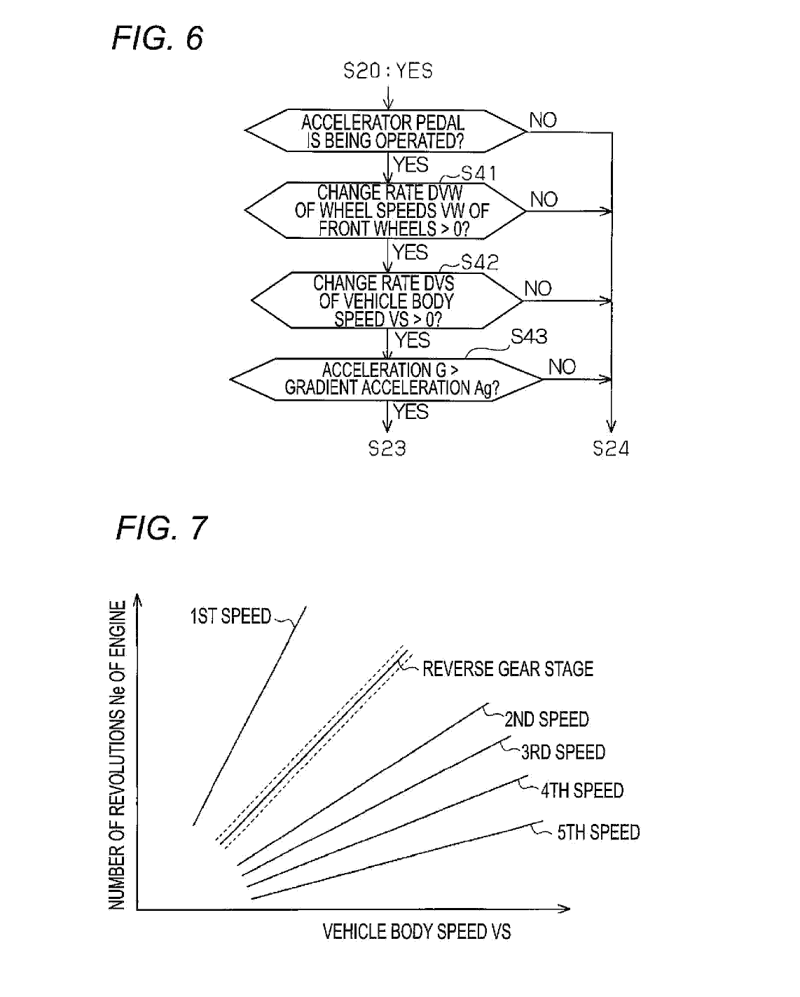

For example, it may be possible to determine whether the vehicle is being accelerated, based on whether the accelerator pedal 11 is being operated, a change rate DVW of the wheel speeds VW of the wheels FR, FL, which are the driving wheels, a change rate DVS of the vehicle body speed of the vehicle and an acceleration G in the forward and backward direction of the vehicle, which is calculated based on a signal output from the forward and backward acceleration sensor SE8. Specifically, as shown in a flowchart of FIG. 6, the brake ECU 35 determines whether the accelerator pedal 11 is being operated (step S40). When a result of the determination is positive, the brake ECU 35 determines whether the change rate DVW of the wheel speeds VW of the front wheels FR, FL, which are the driving wheels, exceeds “0 (zero)” since the accelerator pedal 11 is being operated (step S41). The change rate DVW of the wheel speeds VW of the front wheels FR, FL is a value that is obtained by temporally differentiating the wheel speed VW of the front wheels FR, FL.

When a result of the determination in step S41 is positive (DVW>0), the brake ECU 35 determines whether the change rate DVS of the vehicle body speed VS of the vehicle exceeds “0 (zero)” (step S42). The change rate DVS of the vehicle body speed VS of the vehicle is a value that is obtained by temporally differentiating the vehicle body speed VS. When a result of the determination in step S42 is positive (DVS>0), the brake ECU 35 determines whether the acceleration G in the forward and backward direction of the vehicle, which is calculated based on a signal output from the forward and backward acceleration sensor SE8, exceeds a gradient acceleration Ag (step S43). The gradient acceleration Ag is a gradient of a road on which the vehicle is traveling and is expressed by an acceleration.

Then, when a result of the determination in step S43 is positive (G>Ag), the brake ECU 35 proceeds to the step S23. On the other hand, when at least one result of the determinations in steps S40 to S43 is negative, the brake ECU 35 proceeds to the step S24.

In the forward traveling determination processing routine shown in FIG. 6, the determination process of step S40 may be omitted. In addition, in the forward traveling determination processing routine shown in FIG. 6, the determination process of step S41 may be omitted. Further, in the forward traveling determination processing routine shown in FIG. 6, the determination process of step S42 may be omitted. Also, in the forward traveling determination processing routine shown in FIG. 6, the determination process of step S43 may be omitted. That is, it may be possible to determine whether the vehicle is being accelerated, based on at least one result of the determinations in steps S40 to S43.

In addition, in the step S41 of the forward traveling determination processing routine shown in FIG. 6, it may be determined whether the change rate DVW of the wheel speeds VW of the driven wheels (rear wheels RR, RL) exceeds “0 (zero)”, instead of the driving wheels (front wheels FR, FL).

Further, it may be possible to determine whether the vehicle is being accelerated based on a change rate of the driving force generated in the engine 12, i.e., a change rage of the number of revolutions Ne of the engine 12. The change rage of the number of revolutions Ne of the engine 12 may be detected based on the detection signal from the first revolutions detection sensor SE2. The change rate of the driving force generated in the engine 12 may be detected based on the detection signal from the second revolutions detection sensor SE3.

Further, in the forward traveling determination processing routine shown in FIG. 3, the processes of steps S17, S19, S20 and S21 may be omitted. In this case, when the vehicle is being accelerated backward at a state in which the driving force from the engine 12 is not transmitted to the front wheels FR, FL, it may be falsely determined that the vehicle is traveling forward. However, by adding a determination condition of determining whether the vehicle is being accelerated and thus determining whether the vehicle is traveling forward, it is possible to improve the determination accuracy of whether the vehicle is traveling forward.

Further, a vehicle that has the transmission 16 having transmission gear ratios of respective gear stages shown in FIG. 7 may be used. In this case, the transmission gear ratio of the gear stage of 1st speed is sufficiently higher than the reverse transmission gear ratio Rgr. Accordingly, it is possible to determine whether the gear stage of the transmission 16 is the gear stage of 1st speed or the reverse gear stage, based on a comparison result of the estimated transmission gear ratio Rge and a threshold that is set so as to determine whether the gear stage is the reverse gear stage. According to this configuration, when the vehicle starts at a state in which the gear stage of the transmission 16 is set as the gear stage of 1st speed, it is possible to determine that the vehicle is traveling forward.

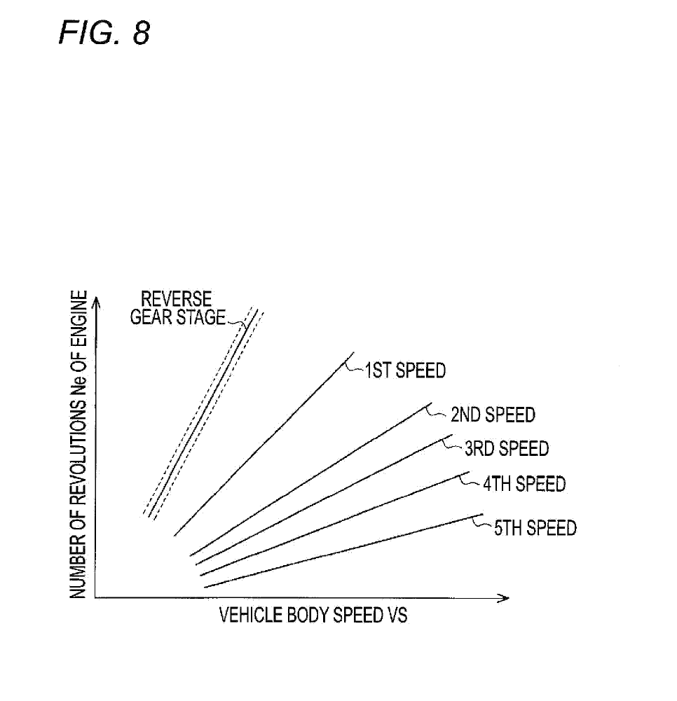

Also, a vehicle that has the transmission 16 having transmission gear ratios of respective gear stages shown in FIG. 8 may be used. In this case, the transmission gear ratio of the gear stage of 1st speed is sufficiently lower than the reverse transmission gear ratio Rgr. Accordingly, it is possible to determine whether the gear stage of the transmission 16 is the gear stage of 1st speed or the reverse gear stage, based on a comparison result of the estimated transmission gear ratio Rge and a threshold that is set so as to determine whether the gear stage is the reverse gear stage. According to this configuration, when the vehicle starts at a state in which the gear stage of the transmission 16 is set as the gear stage of 1st speed, it is possible to determine that the vehicle is traveling forward.

Further, the estimated transmission gear ratio Rge may be calculated by using the number of revolutions after shift transmission, which is calculated based on the detection signal from the second revolutions detection sensor SE3, instead of the average value of the wheel speeds VW of the front wheels FR, FL, which are the driving wheels. In this case, a value that is obtained by dividing the number of revolutions Ne of the engine by the number of revolutions after shift transmission becomes the estimated transmission gear ratio Rge.

Also, the estimated transmission gear ratio Rge may be calculated by using the vehicle body speed of the vehicle, instead of the wheel speeds VW of the front wheels FR, FL. In this case, although the driving force from the engine 12 is not directly expressed, it is convenient in that a value (vehicle body speed) used in the other control can be used.

Also, in the calculation of the estimated transmission gear ratio Rge, the wheel speed VW of one of the front wheels (for example, front right wheel FR) may be used instead of the average value of the wheel speeds VW of the respective front wheels FR, FL.

Further, a vehicle having an automatic transmission mounted therein may be used.

Further, a rear-wheel driving vehicle may be used. In this case, it is preferable to calculate the estimated transmission gear ratio Rge by using an average value of the wheel speeds of the respective rear wheels RR, RL. Also, a four-wheel driving vehicle may be used. In this case, it is preferable to calculate the estimated transmission gear ratio Rge by using an average value of the wheel speeds of the respective wheels FR, FL, RR, RL.

Further, the vehicle may be a so-called electric vehicle in which a motor is mounted, instead of the engine 12 as the driving source, or a so-called hybrid vehicle in which the engine 12 and a motor are mounted as the driving source. In this case, a rotating direction of the motor when the vehicle traveling forward should coincide with a rotating direction of the motor when the vehicle traveling backward.

In the below, the technical concept that can be understood from the above and other illustrative embodiments are further described.

(A) A vehicle forward traveling determination apparatus having an acceleration determination unit (35, S22, S23, S25, S40, S41, S42, S43) which determines whether the vehicle is being accelerated based on at least one of whether the accelerator pedal (11) is operated, the change rate (DVW) of the wheel speeds (VW) of the wheels (FR, FL, RR, RL) mounted to the vehicle, the change rate (DVS) of the vehicle body speed (VS) of the vehicle, a change rate of the number of revolutions (Ne) of the driving source (12) when the driving force is transmitted to the wheels (FR, FL, RR, RL) and the acceleration (G) in the forward and backward direction of the vehicle, which is calculated based on a signal output from the acceleration sensor (SE8) mounted to the vehicle.

(B) A braking control apparatus of a vehicle including the forward traveling determination apparatus and a braking control permission unit (35, S30) that, when the forward traveling determination unit (35, S26) of the forward traveling determination apparatus determines that the vehicle is traveling forward, permits execution of the sideslip suppression control of the vehicle, and when it is determined that the vehicle is not traveling forward, prohibits the execution of the sideslip suppression control.

(C) A vehicle forward traveling determination method includes a first revolutions acquisition step (S13) of acquiring the number of revolutions (Ne) of the driving source 12 of the vehicle and a second revolutions acquisition step (S11, S12) of acquiring a value (VS, VW) corresponding to the number of revolutions at the output side of the transmission 16. In the transmission gear ratio calculation step (S15), the transmission gear ratio Rge is calculated based on the values (Ne, VS, VW) acquired in the respective revolutions acquisition steps (S13, S11, S12).

What is claimed is:

1. A vehicle forward traveling determination apparatus comprising:
a first acquisition unit configured to acquire a number of revolutions of a driving source of a vehicle;
a second acquisition unit configured to acquire a value corresponding to a number of revolutions at an output side of a transmission mounted to the vehicle;
a transmission gear ratio calculation unit configured to calculate a transmission gear ratio based on the respective values acquired in the respective first and second acquisition units;
a gear stage determination unit configured to determine whether a gear stage of the transmission is set in a forward gear stage, based on the transmission gear ratio calculated by the transmission gear ratio calculation unit;
an acceleration determination unit configured to determine whether the vehicle is being accelerated; and
a forward traveling determination unit configured to determine that the vehicle is traveling forward when the gear stage determination unit determines that the gear stage of the transmission is set in the forward gear stage and the acceleration determination unit determines that the vehicle is being accelerated.

2. The vehicle forward traveling determination apparatus according to claim 1, further comprising:
a transmission determination unit configured to determine whether a driving force is transmitted from the driving source to wheels of the vehicle,
wherein the forward traveling determination unit is configured to determine that the vehicle is traveling forward when the gear stage determination unit determines that the gear stage of the transmission is set in the forward gear stage, the acceleration determination unit determines that the vehicle is being accelerated and further the transmission determination unit determines that the driving force is transmitted from the driving source to the wheels.

3. The vehicle forward traveling determination apparatus according to claim 1,
wherein once it is determined that the vehicle is traveling forward, the forward traveling determination unit maintains the determination result until the vehicle is stopped.

4. A vehicle forward traveling determination method comprising:
calculating a transmission gear ratio based on a number of revolutions of a driving source of a vehicle and a value corresponding to a number of revolutions at an output side of a transmission mounted to the vehicle;
determining whether a gear stage of the transmission is set in a forward gear stage based on the calculated transmission gear ratio;
determining whether the vehicle is being accelerated; and
determining that the vehicle is traveling forward when it is determined that the gear stage of the transmission is set in the forward gear stage and it is determined that the vehicle is being accelerated.

5. The vehicle forward traveling determination method according to claim 4,
wherein when it is determined that the vehicle is traveling forward, the determination result is maintained until the vehicle is stopped.
